(19) United States
(12) Patent Application Publication
(10) Pub. No.: US 2002/0071913 A1
(43) Pub. Date: Jun. 13, 2002

(54) Manufacturing device of battery components and process for manufacturing the same

(76) Inventor: Chu Hou Jen, Taipei Hsien (TW)

Correspondence Address: TERESA STANEK REA, ESQUIRE, BURNS, DOANE, SWECKER & MATHIS, L.L.P., P.O. Box 1404, Alexandria, VA, 22313-1404, US

(21) Appl. No.: 10/013,472

(22) Filed: Dec. 13, 2001

(30) Foreign Application Priority Data
Dec. 13, 2000 (TW) 89126586

(51) Int. Cl. B05D 3/06; B05D 3/02; B05D 3/12; B05D 1/18; B05D 5/12

(52) U.S. Cl. 427/299; 427/314; 427/430.1; 427/359; 427/557; 118/123; 118/218

(57) ABSTRACT

The present invention provides a manufacturing device of electrochemical cell components in a battery comprising a preliminary dip tank, baking box, main dip tank, and dipping device, drying tower and consolidating device. The present invention also provides a process for manufacturing electrochemical cell components in a battery comprising applying electrode materials over metal current collector webs or carbon (or glass) fiber fabric webs with dipping, baking and consolidating steps to make various kinds of electrochemical cell components in a battery (e.g. a cathode, anode, and separator) for use in subsequent processes of making a battery.

### FIELD OF THE INVENTION

The present invention relates to a device and process for manufacturing battery components, more particularly, to a manufacturing device of electrochemical cell components in a secondary battery and a process for making the same.

### BACKGROUND OF THE INVENTION

With the fast development of integrated circuit technology, portable electronic products (such as mobile phone, notebook computer, etc.) require high-performance in function, but lighter in weight and thinner, smaller and various in shape. Therefore, the price of a power source, the density of electrical energy (the dimension of a power supply) and the stability of the source are always a major subject of research in the development of the applications. In view of electrical energy, voltage and environmental protection, traditional batteries (like carbon-zinc, alkaline, mercury, or lithium batteries) are gradually replaced by secondary batteries capable of running for longer time and being charged repeatedly. Moreover, in some fields of application, like battery-powered vehicles, aircraft, microelectronic devices and wireless power supplies, secondary batteries provide broader scope for the development in the future.

Generally, the electrochemical cell components in a battery comprise the following parts: an anode current collector web, an anode, a diaphragm, a cathode, and a cathode current collector web. Conventionally, the materials of interest are horizontally applied to a substrate (or fabric web) in industrially manufacturing the cell components in a battery to form the electrodes or separators. However, in case of horizontally coating, the applied materials (e.g. high density metal oxides in a polymer secondary battery) will precipitate during a baking process. In other words, the amount of solid particles in the applied materials near the substrate will be much higher than that near the surface layer, and the solid particles near the substrate will peel after coating. In addition, in a pressing process of making a battery, since the amount of particles is high and the adhesive is relatively insufficient, the electrode and separator cannot well combine with each other. Moreover, in the baking process, a solvent can evaporate only from a side of the substrate, and the evaporated surface will form a film of preventing further evaporation. If the baking temperature is too high, the surface is apt to being cracked. If the baking temperature is too low, the production speed will slow down for sufficiently drying and the particles in the applied materials will precipitate due to the long baking period.

The vertically dipping method did improve the wetting problem and thus increasing the adhesion between the adhesive and the substrate, but the yield is still unsatisfied. As a result, there is still a need to find an improved manufacturing device and process of electrochemical cell components in a battery to solve the problems currently met in the industry; that is, poor yield or high inner electrical resistance results from poor adhesion between the electrodes.

### SUMMARY OF THE INVENTION

The present invention provides a device of manufacturing electrochemical cell components in a battery that integrates several improved device to sufficiently solve the problem of joining electrodes or separator of non-conductive polymer with a substrate. The present invention also provides a process for manufacturing an electrochemical cell components in a battery, by use of pretreatments such as wetting, cleaning and/or gluing, a specific design in a drying device that has vertical laminate flows and subsequent heating and consolidating device, to raise the overall product reliability of the electrochemical cell components in a battery and thus increase the yield. According to the present invention, the complexity of the manufacturing process can be simplified. For example, by changing different batches of solutions in a single dip tank or in separate dip tanks, different products, like anodes, cathodes; or separators, etc., can be made by the same manufacturing device. According to the present invention, the device for manufacturing the electrochemical cell components, which are made of a length of the substrate, comprises a plurality of spools in a unwinding device; a preliminary dip tank which contains liquid materials for cleaning and/or gluing surfaces of the substrate; a first coating device comprising a plurality of rollers contacting with the substrate for conveying the substrate through the liquid materials in the preliminary dip tank; a baking box for drying the dip-coated substrate; a main dip tank which contains a solution which includes a solvent for a cathode, an anode or a separator; a second coating device comprising a plurality of rollers in contact with the substrate which travels through the liquid material; agitating blades for stirring the solution, and a shield disposed between the rollers and the agitating blade to protect the agitating blades from the damage by falling objects; a plurality of squeezing rollers for closely joining the coated materials in the solution with the substrate and for uniformly distributing the thickness of the coating; a vertical drying device comprising a heating device, preferabl a heating device with multi-section radiant heating elements and hot-air inlet(s) and outlet(s); a consolidating device comprising a pair of heating rollers for rolling and consolidating the substrate that travels from the vertical drying device; and a spool in a fabric collector for collecting the solvent-coated and -curried electrochemical cell components about the spools for subsequent processing of making a battery.

These and other objects, features and advantages will be clearly shown in the following more particular description of preferred embodiments. While we have shown and described specific embodiments of the present invention, further modifications and improvements will occur to those skilled in the art. Therefore, it is understood that this invention is not limited to the shown particular forms and covers in the appended claims all modifications that do not depart from the spirit and scope of this invention.

### BRIEF DESCRIPTION OF THE DRAWINGS

FIG. 1 shows a schematic diagram of a device for manufacturing electrochemical cell components according to the present invention.

FIG. 2 shows a preliminary dip tank and a baking box.

FIG. 3 shows a schematic diagram of a main dip device.

FIG. 4 shows a schematic diagram of a conveying line in the drying tower and heat laminate flow.

FIG. 5 shows a schematic diagram of a consolidating device in a closed chamber.

### DETAILED DESCRIPTION OF THE INVENTION

The present invention discloses a manufacturing device and process of electrochemical cell components in a battery. The present invention is directed to eliminating defects that cannot efficiently increase yield in the conventional manufacturing process, and successfully solving the aforementioned problems of joining the components and unfavorable outcomes.

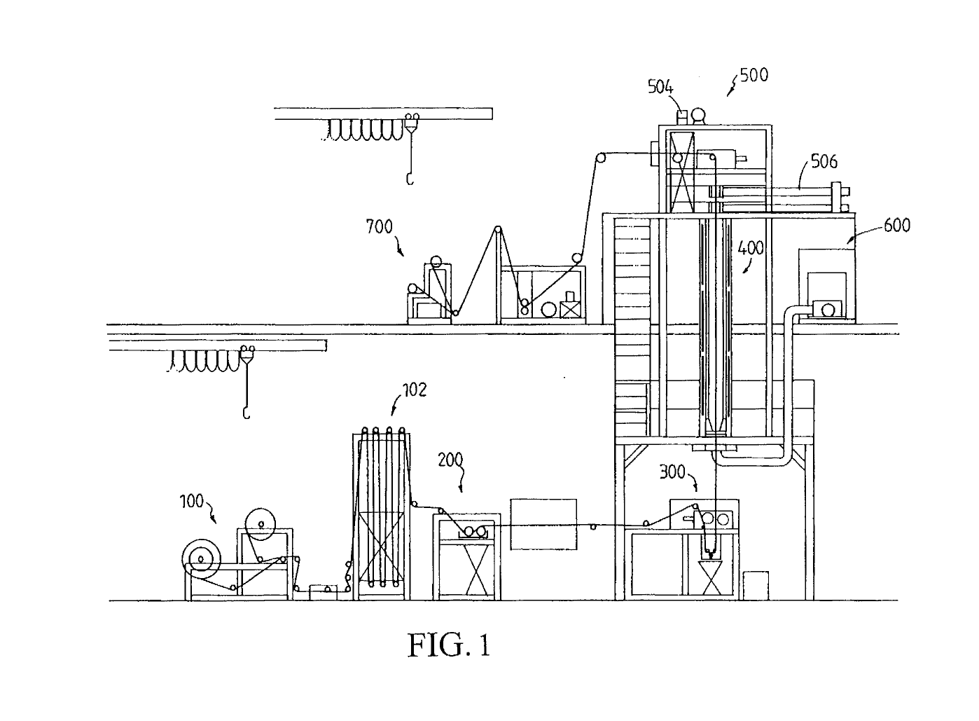

FIG. 1 is a schematic diagram of the manufacturing device of electrochemical cell components in a battery built according to the present invention. An unwinding device 100 includes a plurality of spools 101 to supply an original substrate 10. A fabric-storing device 102 is designed to change the spools 101 for storing the original substrate 10 without interrupting the conveyance of the original substrate 10 in the production line. A pretreatment device 200 comprises one or more preliminary dip tanks 202 and baking boxes 204. Subsequently, a main dip device 300 is used to apply an electrode material or non-conductive polymer on the original substrate 10. Afterward, the coated substrate 20 with the electrode material (or non-conductive material) thereon vertically travels into a vertical drying tower 400 where there is hot air from a blast furnace 600 in the bottom of the tower 400 through the whole drying tower 400 and out of the top of the tower 400. The coated substrate 20 conveyed from the top of the drying tower 400 then enters a closed consolidating device 500 to closely join the coating material with the coated substrate 20. Lastly, cell components 30 made of the coated substrate 20 are wound about a spool 701 in the winder 700 for facilitating subsequent processes. Afterward, the resulting cell components in the battery can be made into a semi-product of a battery by way of the conventional hot-rolling process, or by the hot pressing disclosed in the inventor's previous ROC Patent Application No. 89105811, which the hot pressing comprises cutting the cell components into components of a suitable size, stacking and pressing the cut components.

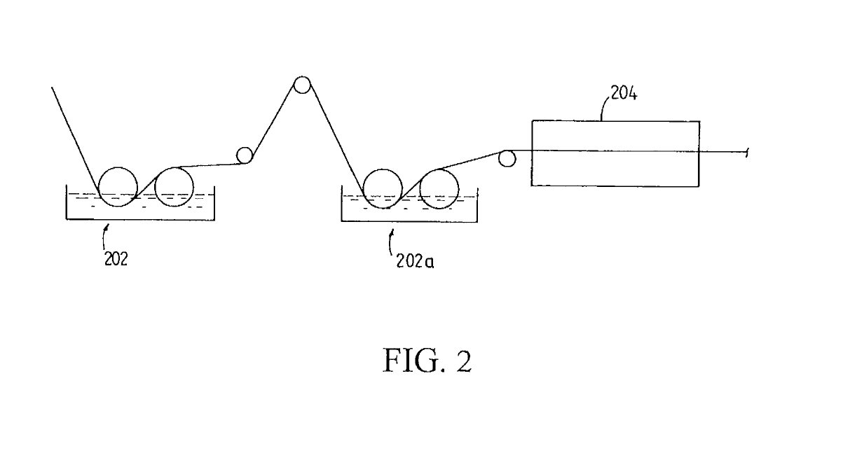

FIG. 2 shows a pretreatment device 200 of the original substrate 10. The device 200 includes at least one preliminary dip tank 202, a baking box 204 and a plurality of rollers 205 206 207 and 208. The function of the preliminary dip tank 202 is to clean an oil-contaminated or the oxidized layer over the surfaces of the original substrate 10 (nonwoven fabric or metal web) due to storage or transportation. These detrimental substances may result in poor adhesion of the coating material to the original substrate 10 or increase the inner electrical resistance of the battery. In addition, one or more preliminary dip tank 202a may be optionally added for applying a glue to the original substrate 10 so as to enhance the coating uniformity and adhesion of the subsequently coating electrode materials. After the preliminary dipping step, the original substrate 10 is baked in the baking box 204.

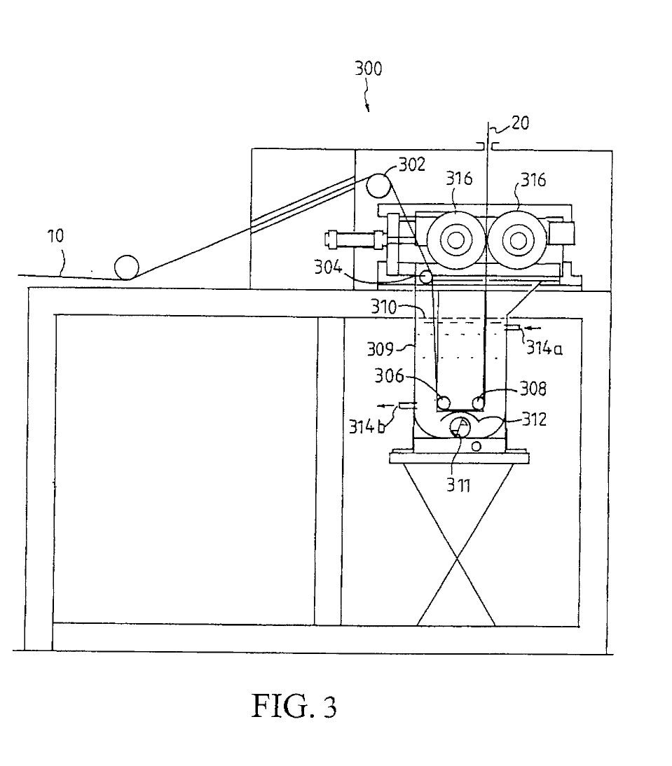

FIG. 3 illustrates a schematic diagram of the main dip device 300 of the present invention. The dried original substrate 10 is then transported to a main dip tank 309 for a primary coating process. The main dip tank 309 comprises a plurality of rollers 302, 304, 306 and 308 for changing the moving direction of the substrate. The main dip tank 309 contains a solution 310, an agitating blade 311 for stirring the solution 310, which contains a cathode, anode, or separator material to be coated. The purpose of stirring the solution 310 is to prevent the solutes with a high specific weight from precipitation in the solution 310 and unevenly coating the original substrate 10. A shield 312 may be provided between the agitating blade 311 and the original substrate 10, to avoid interrupting the production process resulting from heavier objects (such as the solute or broken substrates) falling onto the blade 311. After dipping, the original substrate 10 travels through a pair of squeezing rolls 316 to uniformly and compactly coat the original substrate 10 with the solutes such as the electrode materials in the solution 310.

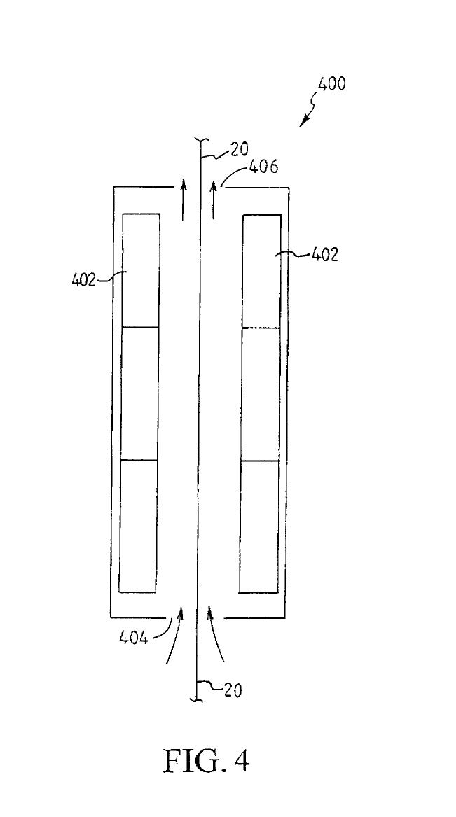

As shown in FIG. 4, the coated substrate 20 moves upward into the vertical drying tower 400. The drying tower 400 comprises heating devices 402 (preferabl a radiant heating source) which may be divided into a plurality of heating zones to optimize the heating efficacy. In addition to the heating device 402, hot air from a blast furnace 600 is introduced through an entrance 404 for the coated substrate 20 and is discharged from a hot-air pipe 406. The purpose of introducing hot air is to form laminate flows in the drying tower 400 as a heat-transfer media, and to take away and recycle evaporated solvents simultaneously. Because the traveling direction of the coated substrate 20 is opposite to that of gravity, the problem of precipitation on the substrate encountered in the prior art can be avoided, and the purpose of stabilizing the quality of the battery is achieved. Moreover, because of the baking box with double-sided baking capability, the solvent in the solution applied on both sides of the coated substrate 20 can be uniformly evaporated. Since the area of evaporation is twice as that in a horizontal machine, the production speed increases.

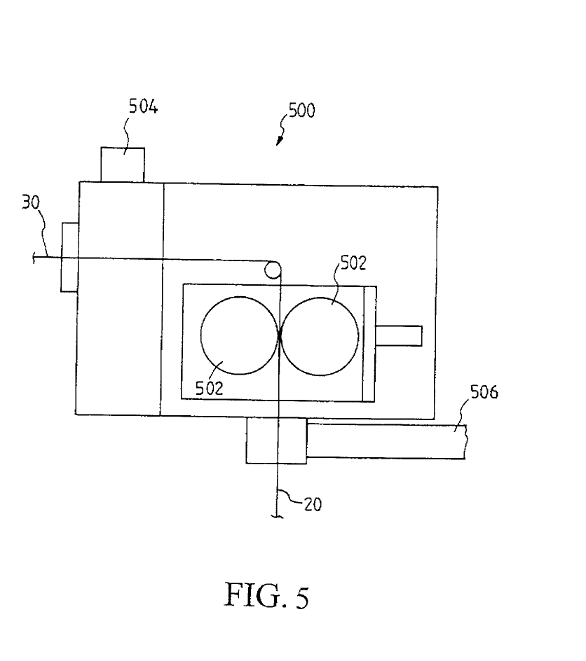

FIG. 5 shows a consolidating device 500 that comprises a pair of heatable squeezing rollers 502 and exhaust pipes 504 and 506. In a closed chamber, the solutes (e.g. electrode materials) can uniformly distributed on the substrate to form cell components 30 by thermal energy from the heatable squeeze rollers 502, as Well as by that of the hot air exhausted from the drying tower 400 and the heat kept in the coated substrate 20. The reason for locating the consolidating device 500 at the top of the drying tower 400 is to well take advantage of hot air and to roll the coated substrate 20 before cooling for saving energy and reducing the cost.

Finally, the formed cell components 30 are rolled into a fabric spool 701 by a fabric winder 700 for subsequent processes.

The efficacies of the manufacturing device of electrochemical cell components in a battery according to the present invention are as follows:

I. Introduction of the Pretreatment Device:

The pretreatment device is used to clean the substrate, e.g. a copper or aluminum metal web, to keep the substrate from contaminants like an oil. The contamination will result in an uneven distribution of the glue as a glue solution is applied over the substrate in the dip tank. In addition, the preliminary dip tank can be used for pretreatment of the surfaces made of the copper or aluminum metal web. If necessary, the copper or aluminum metal web can be coated with a layer of primer to enhance the surface adhesion of the web. The preliminary dip tanks may be arranged in series to achieve the objects of the present invention mentioned above.

II. Enhancement in Uniform Temperature Control of the Vertical Baking Box:

With the preferable radiant heating elements, the thermal energy can be radiatively transferred from the surfaces of heating elements to the object to be dried. At the same time, hot air is introduced into the baking box to take away the solvent and leave the solutes (e.g. electrode materials) behind. The introduction of hot air can also form the laminate flows that act as a heat-transfer medium to provide efficiently thermal energy for drying. The flow rate of the introduced hot air is pre-calculated to sufficiently evaporate the solution on the substrate and to cure the solute of interest disposed on the substrate, without an adverse effect of high temperature on the coating. In addition, the heating elements in the baking box can be divided into multiple sections that independently control the drying temperature to increase the baking efficiency. The above designs can be applied in combination to achieve the object of uniformly distributing temperature or drying, and thus increase the throughout.

III. Agitation in the Main Dip Tank:

The purpose of agitating is to prevent the precipitation of the solutes with a high specific weight, and uniformly distribute the solutes in the solution of the main dip tank. Moreover, a shield is equipped above the agitating blade for protection.

IV. Consolidation Process:

In consolidation, it is necessary to exercise a pressure on the substrate and heat the substrate by the squeezing rollers. According to the present invention, the consolidating device is set on the top of the baking box in order to efficiently recycle the thermal energy dissipating from the baking box in the closed chamber, and thus to reduce the cost of the battery products.

V. The Reduction of Investment in Production Equipment:

According to the present invention, an electrically conductive substrate, e.g. current collector web or carbon-fiber nonwoven fabric web, can be directly coated with the materials such as a cathode or anode, or a substrate can be coated with materials, e.g. polyethylene or polyethylene terephthalate (PET) as a separator film, so that a coating carrier like a releasing film can be eliminated and cost can be reduced. Moreover, the same manufacturing device can be used for producing the current collector web-contained electrodes or separators by simply changing the coating solution in the dip tanks.

By the foregoing description, various processes embodying the present invention have been disclosed. However, numerous modifications and substitutions may be made without deviating from the scope of the present invention. Therefore, the above illustration is to disclose the present invention but not to limit the scope thereof.

What is claimed is:

1. A manufacturing device of an electrochemical cell component made of a length of a substrate, the manufacturing device comprising:
an unwinding device comprising at least one spool with said substrate wound thereon;
a preliminary dip tank comprising a first solution for cleaning and/or applying a glue on surfaces of said substrate;
a first coating device comprising a roller contacting with said substrate for moving said substrate through said first solution in said preliminary dip tank;
a baking box for baking the preliminarily dipped substrate;
a main dip tank comprising a second solution containing a cathode, anode or separator material;
a second coating device comprising at least one roller contacting with said substrate for moving said substrate through said second solution; an agitating blade for stirring said second solution; and a shield disposed between said roller and agitating blade for protecting said agitating blade from the damage by falling objects;
a pair of squeezing rollers for consolidating said material in said second solution to evenly distribute said material on said substrate;
a vertical drying device comprising a heating device, a hot air inlet and a hot air outlet for baking the coated substrate; and
a consolidating device comprising a heatable squeezing rollers for heating and consolidating the coated substrate that travels from said vertical drying device to form an electrochemical cell component in a battery.

2. The manufacturing device according to claim 1, wherein said heating device in said vertical drying device is a multi-section heating device.

3. The manufacturing device according to claim 2, wherein said heating device in said vertical drying device is a multi-section radiant heating device.

4. The manufacturing device according to claim 1, further comprising:
a fabric-storing device for keeping the movement of said substrate when the spool is replaced; and
a winder comprising at least one spool for winding said electrochemical cell component for use in subsequent processes of making a battery.

5. The manufacturing device according to claim 1, wherein said hot inlet and said outlet are located at a first end and second end of said drying device respectively.

6. The manufacturing device according to claim 1, wherein said consolidating device is provided in a closed chamber to save thermal energy.

7. The manufacturing device according to claim 1, wherein said electrochemical cell component is a cathode, an anode, or a separator.

8. The manufacturing device according to claim 1, wherein said substrate is a metal current collector web, carbon fiber nonwoven fabric web or glass fiber nonwoven fabric web.

9. A manufacturing process of an electrochemical cell component comprising the steps of:
dipping a substrate in a first solution as a pretreatment;
drying said substrate;
dipping said substrate in a second solution to apply a layer of a material on the substrate;
rolling said coated substrate;
conveying said substrate in a direction opposite to that of gravity into a drying device and baking said substrate; and
consolidating said substrate from said drying device.

10. The manufacturing process according to claim 9, wherein said baking step is conducted with radiant heat.

11. The manufacturing process according to claim 9, wherein said baking step further comprises drying said substrate with hot air.

12. The manufacturing process according to claim 9, wherein said consolidating step comprises the steps of heating and rolling the substrate in a closed chamber.

13. The manufacturing process according to claim 9, wherein said first solution is a cleaning, a gluing or a cleaning/gluing solution.

14. The manufacturing process according to claim 9, wherein said material in said second solution for coating the surface of said substrate is a cathode, an anode material, or a non-conductive polymeric material.
